(19) United States
(12) Patent Application Publication
(10) Pub. No.: US 2026/0302065 A1
(43) Pub. Date: Oct. 1, 2026

(54) MULTILAYER CERAMIC ELECTRONIC DEVICE AND DIELECTRIC CERAMIC COMPOSITION

(71) Applicant: TAIYO YUDEN CO., LTD., Tokyo (JP)

(72) Inventor: Kohta NAMBU, Takasaki-shi (JP)

(21) Appl. No.: 19/560,605

(22) Filed: Mar. 9, 2026

(30) Foreign Application Priority Data
Mar. 28, 2025 (JP) 2025-055549

(51) Int. Cl. H01G 4/12; C04B 35/475; C04B 37/00; H01G 4/30

(52) U.S. Cl. CPC H01G 4/1227; C04B 35/475; C04B 37/001; H01G 4/30; C04B 2235/3234; C04B 2235/3262; C04B 2235/428; C04B 2235/786; C04B 2237/346; C04B 2237/62

(57) ABSTRACT

A multilayer ceramic electronic device includes at least two internal electrode layers facing each other, a dielectric layer that is sandwiched by the two internal electrode layers, has a plurality of dielectric grains including bismuth, sodium, niobium, titanium, silicon, and manganese, and has a segregation portion that is arranged on a grain boundary of the plurality of dielectric grains and includes bismuth, silicon, and manganese, and external electrodes respectively electrically connected to the two internal electrode layers.

### CROSS-REFERENCE TO RELATED APPLICATION

This application is based upon and claims the benefit of priority of the prior Japanese Patent Application No. 2025-055549, filed on Mar. 28, 2025, the entire contents of which are incorporated herein by reference.

### FIELD

A certain aspect of the present disclosure relates to a multilayer ceramic electronic device and a dielectric ceramic composition.

### BACKGROUND

Multilayer ceramic electronic devices such as multilayer ceramic capacitors (MLCCs) (see, for example, Japanese Patent Application Publication No. 2016-60647 hereinafter referred to Patent Document 1 and Japanese Patent Application Publication No. 2016-56058 hereinafter referred to Patent Document 2) are used to eliminate noise in high-frequency communication systems, such as mobile phones. In particular, in the field of power electronics, there is a demand for capacitors that can operate under high temperatures and voltages for applications such as stable power supply, motor drive control, and power conversion devices. Demand for these devices is expected to increase further in the future due to the spread of electric vehicles and other vehicles.

### SUMMARY OF THE INVENTION

According to an aspect of the embodiments, there is provided a multilayer ceramic electronic device including: at least two internal electrode layers facing each other; a dielectric layer that is sandwiched by the two internal electrode layers, has a plurality of dielectric grains including bismuth, sodium, niobium, titanium, silicon, and manganese, and has a segregation portion that is arranged on a grain boundary of the plurality of dielectric grains and includes bismuth, silicon, and manganese; and external electrodes respectively electrically connected to the two internal electrode layers.

According to another aspect of the embodiments, there is provided a dielectric ceramic composition including: a plurality of dielectric grains including bismuth, sodium, niobium, titanium, silicon, and manganese; and a segregation portion that is arranged on a grain boundary of the plurality of dielectric grains and includes bismuth, silicon, and manganese.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged cross-sectional views of vicinity of external electrodes;

FIG. 5 illustrates a schematic cross-sectional view of a dielectric layer;

FIG. 6A and FIG. 6B are schematic cross-sectional views illustrating details of a dielectric layer;

FIG. 7A is a STEM image of sintered body with addition of manganese and silicon;

FIG. 7B is a STEM image of sintered body with addition of manganese but without silicon;

FIG. 8A to FIG. 8C are SEM images of sintered bodies with and without manganese and silicon, respectively, compared;

FIG. 9 illustrates SEM images of sintered bodies compared based on a difference in manganese concentration in a segregation portion containing manganese and silicon;

FIG. 10 illustrates a flow of a manufacturing method for a multilayer ceramic capacitor;

FIG. 11A and FIG. 11B illustrate a printing process; and

FIG. 12 illustrates a pressing and bonding process.

### DETAILED DESCRIPTION

In multilayer ceramic electronic devices, cracks, peeling, or other fractures can occur in the dielectric composition-containing element, body leading to failure. The primary cause of fracture is stress generated in the internal electrodes when DC or AC voltage is applied to the multilayer ceramic electronic device. In ceramics with significant brittleness, this stress may cause cracks and reduce the reliability of the multilayer ceramic electronic device. Other contributing factors include thermal stress resulting from the difference in thermal expansion coefficients between the element body and the internal electrode layers during firing, deformation stress applied to the multilayer ceramic electronic device during board mounting, and external impacts to the element body. In particular, when multilayer ceramic electronic devices are used as automotive components, they are subject to continuous vibration and impact, requiring materials with excellent Vickers hardness and fracture toughness.

In Patent Document 1, a rare earth element is added to a mixture of (Bi,Na)TiO₃ and SrTiO₃ to improve the relative dielectric constant when a DC bias is applied. However, there is no mention of mechanical properties such as Vickers hardness, and it is unclear whether the resulting material has sufficient strength for practical use.

Patent Document 2 reports that the use of a tungsten bronze-type composite oxide material results in excellent high-temperature load life. However, there is no mention of mechanical properties such as Vickers hardness, raising concerns about practical mechanical strength.

“M. Li, M. J. Pietrowski, R. A. D. Souza, H. Zhang, I. M. Reaney, S. N. Cook, J. A. Kilner, D. C. Sinclair, A family of oxide ion conductors based on the ferroelectric perovskite Na_{0.5}Bi_{0.5}TiO₃, Nat. Mater. 13 (2014) 31. https://doi.org/10.1038/NMAT3782.” also reports that bismuth volatilizes during the firing process of (Bi,Na) TiO₃, resulting in a decrease in electrical resistance and a change in the conduction mechanism. Furthermore, it is known that bismuth volatilization in bismuth-based oxides causes abnormal grain growth and results in a non-uniform microstructure. Based on these findings, bismuth volatilization impairs the reliability and reduces the mechanical strength of multilayer ceramic electronic devices, making it a problem that should be resolved.

Hereinafter, an exemplary embodiment will be described with reference to the accompanying drawings.

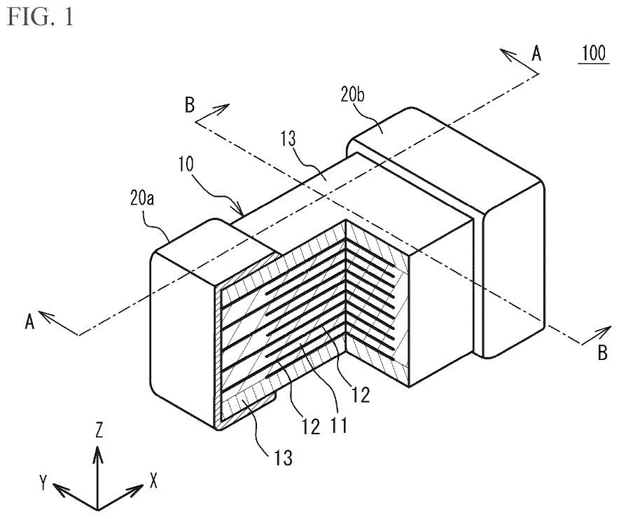

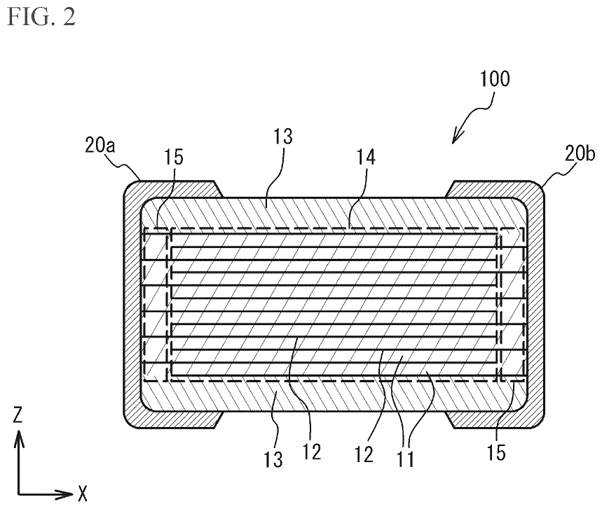

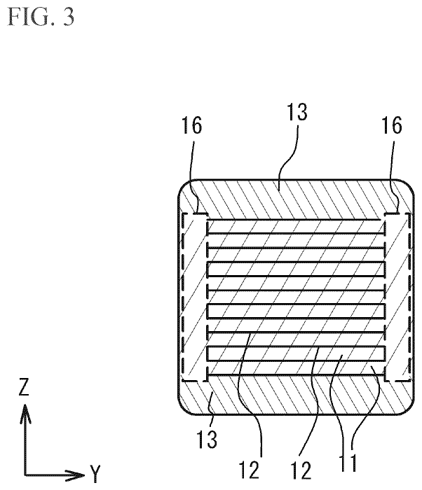

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the element body 10. The X-axis direction is a direction in which the two end faces of the element body 10 are opposite to each other and in which the external electrode 20a is opposite to the external electrode 20b. A Y-axis direction (third direction) is a width direction of the internal electrode layers. The Y-axis direction is a direction in which the two side faces of the element body 10 are opposite to each other. The X-axis direction, the Y-axis direction and the Z-axis direction are orthogonal to each other.

The element body 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIG. 1 to FIG. 3, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is silver (Ag), silver-palladium (Pd) alloy, platinum (Pt) or the like. The thickness of the internal electrode layer 12 is, for example, 0.1 μm or more and 3.0 μm or less, 0.1 μm or more and 2.5 μm or less, or 0.1 μm or more and 2.0 μm or less. The thickness of the internal electrode layers 12 can be measured by observing a cross section of the multilayer ceramic capacitor 100 with a scanning electron microscope (SEM), measuring the thickness at 10 points for each of 10 different internal electrode layers 12, and deriving the average value of all the measurement points.

The dielectric layer 11 is primarily composed of a dielectric ceramic composition (ceramic material) with a perovskite structure represented by the general formula ABO₃. This perovskite structure includes ABO_{3-α}, which deviates from the stoichiometric composition. In this embodiment, the dielectric ceramic composition is a ceramic containing bismuth, sodium, niobium, titanium, silicon, and manganese. For example, the dielectric layers 11 contain 90 at % or more of the main component ceramic. The thickness of the dielectric layer 11 is, for example, 1 μm or more and 100 μm or less, 2 μm or more and 60 μm or less, or 3 μm or more and 50 μm or less. The thickness of the dielectric layers 11 can be measured by observing a cross section of the multilayer ceramic capacitor 100 with a scanning electron microscope (SEM), measuring the thickness at 10 points for each of the 10 different dielectric layers 11, and deriving the average value of all the measurement points.

The dielectric layer 11 may contain an additive. The additive is such as an oxide of zirconium (Zr), hafnium (Hf), magnesium (Mg), manganese (Mn), molybdenum (Mo), vanadium (V), chromium (Cr), barium (Ba), strontium (Sr), calcium (Ca), or a rare earth element (yttrium (Y), samarium (Sm), europium (Eu), gadolinium (Gd), terbium (Tb), dysprosium (Dy), holmium (Ho), erbium (Er), thulium (Tm), or ytterbium (Yb)), an oxide containing cobalt (Co), nickel (Ni), lithium (Li), boron (B), potassium (K), or silicon (Si), or a glass containing cobalt, nickel, lithium, boron, sodium, potassium, or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

In the YZ cross section, the cover layer 13 and the side margins 16 form the outer periphery of the capacity section 14. Therefore, hereinafter, the portion forming the outer periphery of the capacity section 14 in the YZ cross section may collectively be referred to as an outer periphery. Note that the cover layer 13 refers to the portion of the outer periphery in the YZ cross section that is above the uppermost internal electrode layer 12 in the Y-axis direction. Therefore, the capacity section 14 and the pair of side margins are sandwiched between the two cover layers 13.

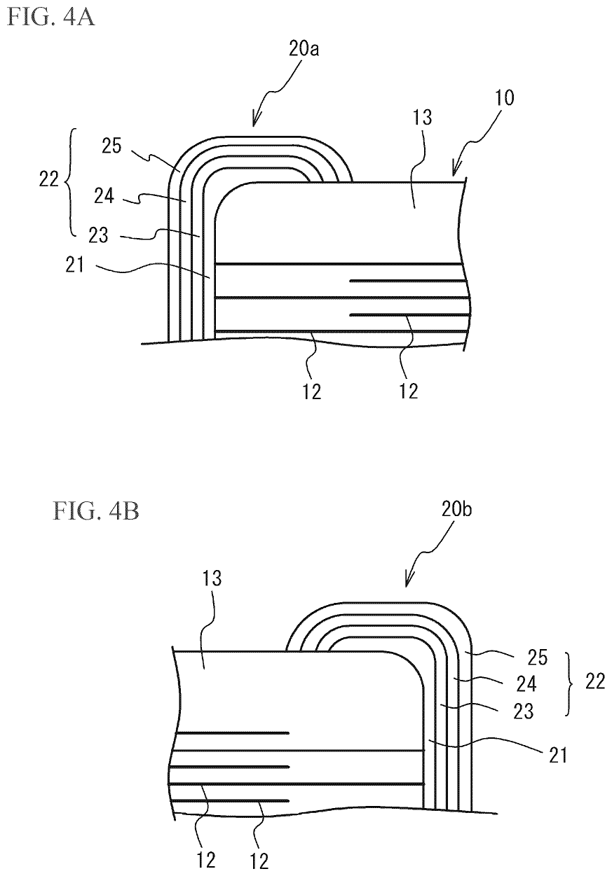

FIG. 4A is an enlarged cross-sectional view of the vicinity of the external electrode 20a. FIG. 4B is an enlarged cross-sectional view of the vicinity of the external electrode 20b. In FIG. 4A and FIG. 4B, hatches are omitted. As illustrated in FIG. 4A and FIG. 4B, the external electrodes 20a and 20b have a structure in which a plated layer 22 is provided on a base layer 21. The base layer 21 is primarily composed of nickel, copper, or the like. The base layer 21 may contain a ceramic grain or a glass component as a co-material. The plated layer 22 is primarily composed of a metal such as nickel, copper, aluminum, zinc, or tin, or an alloy of two or more of these metals. The plated layer 22 may be a plated layer of a single metal component or multiple plated layers of different metal components. For example, the plated layer 22 has a structure in which a first plated layer 23, a second plated layer 24, and a third plated layer 25 are formed in this order from the base layer 21 side. The first plated layer 23 is, for example, a copper plated layer. The second plated layer 24 is, for example, a nickel plated layer. The third plated layer 25 is, for example, a tin plated layer.

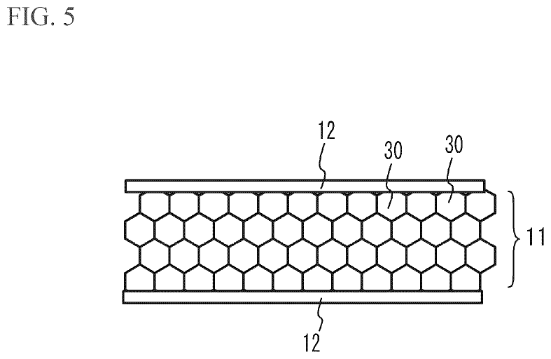

FIG. 5 is a schematic cross-sectional view of the dielectric layer 11. As illustrated in FIG. 5, the dielectric layer 11 has a structure in which a plurality of dielectric grains 30 that constitute the main phase are sintered. For example, the number of the dielectric grain 30 in the thickness direction in the dielectric layer 11 may be one. The dielectric layer 11 may have a structure in which the plurality of dielectric grains 30 are continuous through grain boundaries as illustrated in FIG. 5. The dielectric grain 30 is a crystal grain of the dielectric ceramic composition which is the main component of the dielectric layer 11.

The dielectric grains 30 are the dielectric ceramic composition described above. The dielectric ceramic composition may be (BiₐNa_{b})(Ti_{c}Nb_{d})O₃, which contains silicon and manganese. This allows the dielectric constant to be maintained high when a DC bias is applied, while suppressing changes in the dielectric constant over a wide temperature range. For example, in (BiₐNa_{b})(Ti_{c}Nb_{d})O₃, the following relationships may be satisfied: 0.1<a<0.5, 0.4<b<0.8, 0.4<c<0.8, and 0.2<d<0.5.

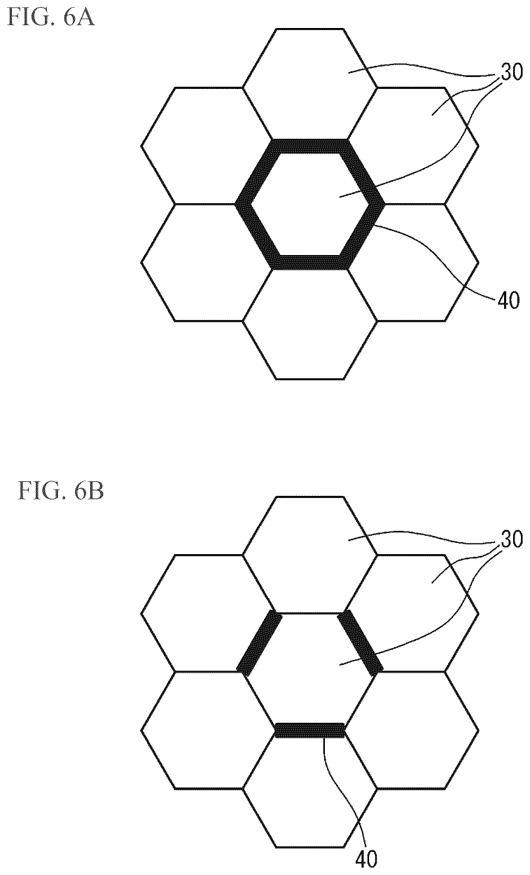

FIG. 6A and FIG. 6B are schematic cross-sectional views illustrating the details of the dielectric layer 11. As illustrated in FIG. 6A, in the dielectric layer 11, a segregation portion 40 is present at a grain boundary formed by the multiple dielectric grains 30. The segregation portion 40 may be segregated throughout the entire grain boundary of the dielectric grain 30, as illustrated in FIG. 6A, or may be segregated to at least a portion of the grain boundary of the dielectric grain 30, as illustrated in FIG. 6B. Therefore, the two dielectric grains 30 may be adjacent to each other without the segregation portion 40 in between.

The segregation portion 40 contains bismuth, silicon, and manganese. Silicon functions as a sintering aid. Through extensive research, the inventors have found that the inclusion of manganese and silicon, which functions as a sintering aid, in the segregation portion 40 increases the bonding strength between the multiple dielectric grains 30, resulting in high strength (for example, high Vickers hardness). Furthermore, through extensive research, the inventors have found that the inclusion of manganese and silicon in the segregation portion 40 suppresses the volatilization of bismuth from the dielectric grain 30. Bismuth segregated at the grain boundary relieves stress on crack tips in the dielectric structure when external stress is applied, resulting in high Vickers hardness and therefore high fracture toughness. As described above, it has been discovered that the dielectric ceramic composition of this embodiment can suppress bismuth volatilization and achieve high strength. Details are explained below.

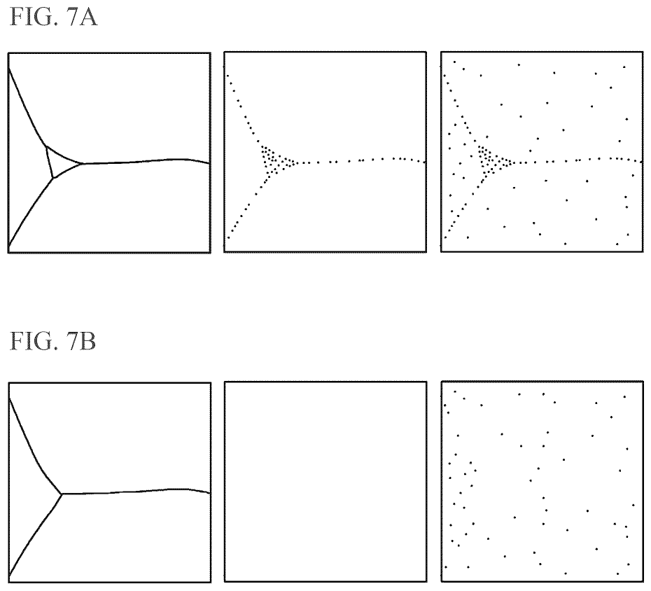

FIG. 7A is an STEM image of a sintered (BiₐNa_{b})(Ti_{c}Nb_{d})O₃ ceramic powder, which constitutes the main phase, to which manganese and silicon have been added. STEM stands for scanning transmission electron microscope. As illustrated in the STEM image on the left of FIG. 7A, grain boundaries are formed between multiple dielectric grains. As illustrated in the EDS (Energy Dispersive X-ray Spectroscopy) image (silicon measurement results) in the center of FIG. 7A, silicon is located at the grain boundary. Furthermore, as illustrated in the EDS image on the right of FIG. 7A (manganese measurement results), manganese is also located at the grain boundary. These findings indicate that the segregation portion 40 containing manganese and silicon has formed at the grain boundary.

FIG. 7B is an STEM image of a ceramic powder of (BiₐNa_{b})(Ti_{c}Nb_{d})O₃, which constitutes the main phase, sintered with manganese added but without silicon. As illustrated in the STEM image on the left of FIG. 7B, a grain boundary has formed between the multiple dielectric grains. As illustrated in the EDS image in the middle of FIG. 7B (silicon measurement results), no silicon has been detected. Furthermore, as illustrated in the EDS image on the right of FIG. 7B (manganese measurement results), manganese has dispersed. These findings indicate that the segregation portion 40 containing manganese and silicon has not formed at the grain boundary.

From the above, it can be seen that the segregation portion 40 is formed when the dielectric layer 11 contains both manganese and silicon.

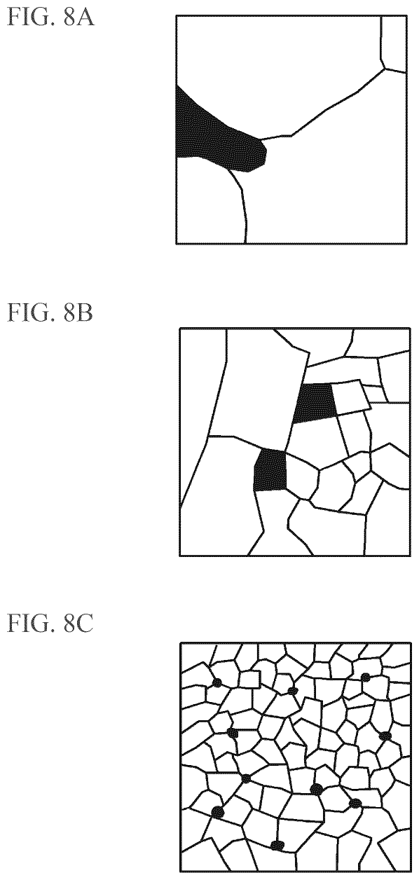

FIG. 8A to FIG. 8C are SEM images of sintered bodies obtained by sintering ceramic powder of (BiₐNa_{b})(Ti_{c}Nb_{d})O₃, which constitutes the main phase, with and without manganese and silicon, respectively, for comparison. FIG. 8A illustrates a sintered body obtained without the addition of either manganese or silicon. When neither manganese nor silicon is added, very large crystal grains and pores (black areas) are formed. This is thought to be due to the volatilization of bismuth from the dielectric grains that constitute the main phase.

FIG. 8B is an SEM image of a sintered body obtained without the addition of manganese but with the addition of silicon. Although the crystal grain size is slightly smaller than when neither manganese nor silicon was added, it remains coarse. This is also thought to be due to bismuth volatilization from the dielectric grains that constitutes main phase.

FIG. 8C is an SEM image of a sintered body when both manganese and silicon are added. It can be seen that when both manganese and silicon are added, the porosity is significantly reduced and the crystal grain size is also refined. This is thought to be because the formation of segregation portion containing manganese and silicon suppressed the volatilization of bismuth.

From the above, it can be seen that the formation of the segregation portion 40 suppresses the volatilization of bismuth.

By suppressing bismuth volatilization and preventing abnormal grain growth, the dielectric grains 30 can be made finer and denser. For example, the average grain size of the dielectric grains 30 in the dielectric layer 11 can be made less than 3.0 μm. The average grain size of the dielectric grains 30 in the dielectric layer 11 can also be set to 0.1 μm or more and 3.0 μm, or less 0.1 μm or more and 2.5 μm or less, or 0.1 μm or more and 2.0 μm or less. The average grain size of the dielectric grains 30 can be measured by identifying 300 or more grains in a single SEM photograph of the cross section and averaging the maximum diameters of the dielectric grains across five SEM images.

Furthermore, the segregation portion 40 can enhance the diffusion barrier for diffusion-limiting element species, thereby suppressing grain growth of the dielectric grains 30. The increase in grain boundary volume associated with the refinement of the dielectric grains 30 suppresses the formation of pores and initial cracks that can initiate fracture, thereby improving toughness and strength. Furthermore, the formation of a fine-grained structure increases the grain boundary volume within the sintered compact structure, thereby increasing the obstacles to crack propagation described above, resulting in higher toughness. Furthermore, the refinement of the dielectric grains 30 also reduces the thickness of the dielectric layer 11, improving capacitance density.

To ensure sufficient segregation of manganese in the segregation portion 40, the manganese concentration in the segregation portion 40 is preferably higher than the manganese concentration in the dielectric grain 30. For example, the manganese concentration in the segregation portion 40 is preferably at least 2.0 times, more preferably at least 4.0 times, and even more preferably at least 8.0 times, the manganese concentration in the segregation portion 40 relative to the manganese concentration in the dielectric grain 30. The manganese concentration in the segregation portion 40 and the manganese concentration in the dielectric grain 30 may be quantitatively analyzed using EDX (Energy Dispersive X-ray Spectroscopy).

From the perspective of ensuring sufficient segregation of silicon in the segregation portion 40, the silicon concentration in the segregation portion 40 is preferably higher than the silicon concentration in the dielectric grain 30. For example, the silicon concentration in the segregation portion 40 is preferably 3.0 times or more, more preferably 3.5 times or more, and even more preferably 4.0 times or more, of the silicon concentration in the dielectric grain 30. The silicon concentration in the segregation portion 40 and the silicon concentration in the dielectric grain 30 may be quantitatively analyzed using EDX.

From the perspective of uniform dispersion in the grain boundaries, it is preferable to set a lower limit for the bismuth concentration in the segregation portion 40. In this embodiment, the bismuth concentration in the segregation portion 40 is preferably 2.0 at % or more, more preferably 4.0 at % or more, and even more preferably 6.0 at % or more. The bismuth concentration in the segregation portion 40 may be quantitatively analyzed by EDX.

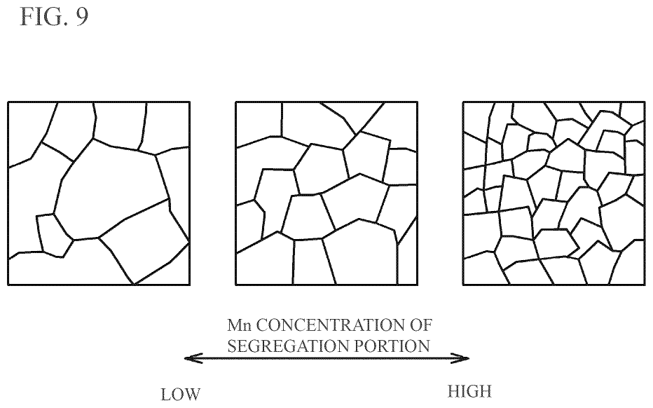

FIG. 9 illustrates SEM images of sintered body compared based on the difference in manganese concentration in the segregation portion containing manganese and silicon. When the manganese concentration in the segregation portion 40 is low, the bonding strength between dielectric grains also decreases, preventing the crack propagation described above from fully manifesting, and the fracture toughness value decreases. On the other hand, when the content of sintering aid is high, the crystal grains of the sintered body approach a cubic shape, creating steric hindrance and preventing densification. As a result, the porosity increases significantly, reducing toughness and fracture strength.

For these reasons, it is preferable to set a lower limit for the manganese concentration in the segregation portion 40. For example, the manganese concentration in the segregation portion 40 is preferably at least 2.0 times the manganese concentration in the dielectric grain 30, more preferably at least 4.0 times, and even more preferably at least 8.0 times.

It is also preferable to set an upper limit for the silicon concentration in the segregation portion 40. For example, the silicon concentration in the segregation portion 40 is preferably 30.0 times or less, more preferably 20.0 times or less, and even more preferably 10.0 times or less, the silicon concentration in the dielectric grain 30.

From the perspective of dielectric properties, it is preferable to set an upper limit on the bismuth concentration in the segregation portion 40. For example, the bismuth concentration in the segregation portion 40 is preferably 20.0 at % or less, more preferably 15.0 at % or less, and even more preferably 12.0 at % or less.

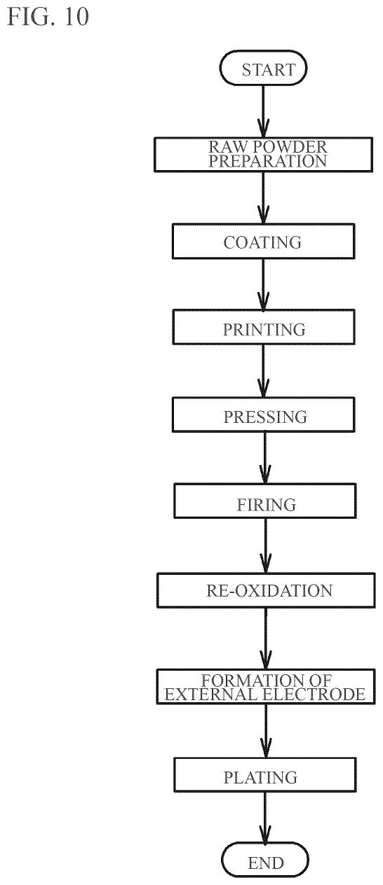

Next, a description will be given of a manufacturing method of the multilayer ceramic capacitors 100. FIG. 10 illustrates a manufacturing method of the multilayer ceramic capacitor 100.

(Preparation process of raw material powder) First, the dielectric material for forming the dielectric layer 11 is prepared. The dielectric material is a powder containing bismuth, sodium, titanium, and niobium. Each component is weighed according to the formula (BiₐNa_{b})(Ti_{c}Nb_{d})O₃.

The obtained powder is added with a predetermined additive compound depending on the purpose to produce the dielectric material, the cover material, and the reverse pattern material, respectively. As the additive compound, zirconium, hafnium, magnesium, manganese, molybdenum, vanadium, chromium, a rare earth element (yttrium, samarium, europium, gadolinium, terbium, dysprosium, holmium, erbium, thulium, or ytterbium) or an oxide of cobalt, nickel, lithium, boron, sodium, potassium or silicon, or a glass including cobalt, nickel, lithium, boron, sodium, potassium or silicon. For example, manganese and silicon are added in the form of MnCO₃ powder and SiO₂ powder.

(Coating process) Next, a binder such as polyvinyl butyral (PVB) resin, an organic solvent such as ethanol or toluene, and a plasticizer are added to the obtained dielectric material and wet-mixed. Using the obtained slurry, a dielectric green sheet 51 is formed on the substrate by, for example, a die coater method or a doctor blade method, and dried. The substrate is, for example, polyethylene terephthalate (PET) film.

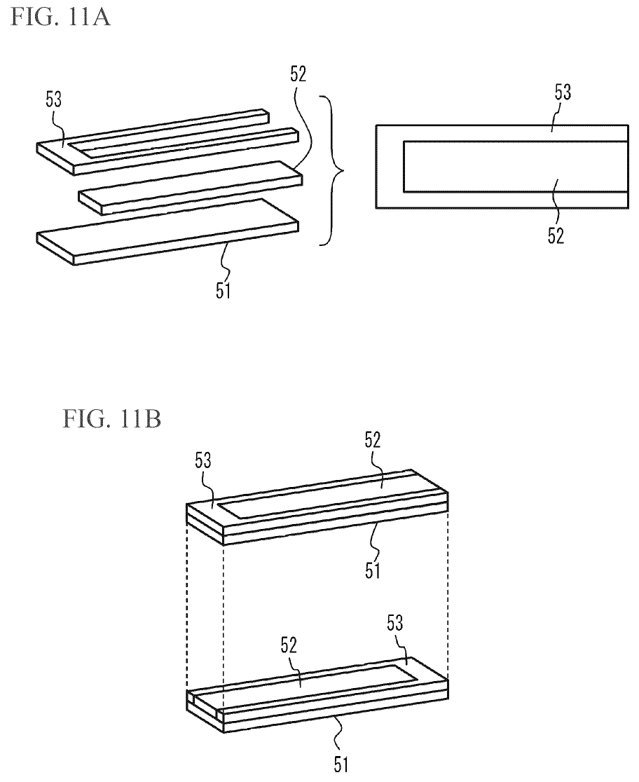

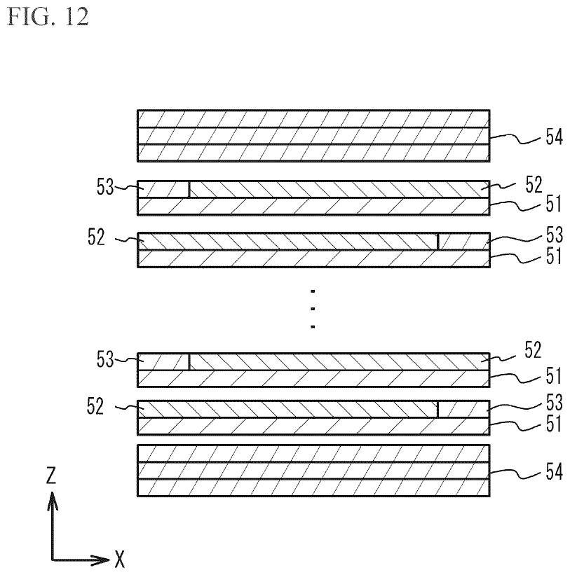

(Printing process) Next, as illustrated in FIG. 11A, a metal conductive paste for forming internal electrodes containing an organic binder is printed on the surface of the dielectric green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11.

Next, a binder such as ethyl cellulose and an organic solvent such as terpineol are added to the dielectric pattern material obtained in the preparation process of the raw material powder, and the mixture is kneaded in a roll mill to form a dielectric pattern paste for the reverse pattern layer. As illustrated in FIG. 11A, a dielectric pattern 53 is formed by printing the resulting slurry in the peripheral region, where the internal electrode pattern 52 is not printed, on the dielectric green sheet 51 to cause the dielectric pattern 53 and the internal electrode pattern 52 to form a flat surface. The dielectric green sheet 51 on which the internal electrode pattern 52 and the dielectric pattern 53 are printed is referred to as a stack unit. The dielectric material described above may be used as the material of the dielectric pattern 53.

Thereafter, as illustrated in FIG. 11B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 to 1000.

(Pressing process) Next, a binder such as an ethyl cellulose-based binder and an organic solvent such as a terpineol-based binder are added to the cover material and kneaded in a roll mill to obtain a cover sheet 54. As illustrated in FIG. 11, a predetermined number of the cover sheets 54 are stacked on top and bottom of a multilayer body in which the stack units are stacked, and then pressed and bonded. The stack body is then cut to a predetermined chip size (for example, 1.0 mm×0.5 mm).

(Firing Process) Thereafter, the binder is removed in an N₂ atmosphere, and then the mixture is fired in the air at a temperature range of 900° C. to 1150° C. for 5 minutes to 10 hours.

(Re-oxidation process) A re-oxidation process may then be performed in an N₂ gas atmosphere at 600° C. to 1000° C. Through these processes, the element body 10 is fabricated.

(External Electrode Formation Process) A metal paste containing the metal for the base layer 21 of the external electrodes 20a, 20b is then applied to the two end faces of the element body 10 using a dip method and baked.

(Plating Process) Then, a metal coating of Cu, Ni, Sn, and so on is applied to the base layer 21 using a plating process. Through these processes, the multilayer ceramic capacitor 100 is completed.

In the above embodiments, a multilayer ceramic capacitor has been described as an example of a multilayer ceramic electronic device, but this is not limiting. For example, other multilayer ceramic electronic devices such as varistors and thermistors may also be used.

### Example

Oxide raw materials of bismuth, sodium, niobium, and titanium were prepared as starting materials. The raw material powders were weighed according to the following formula (1). a, b, d, and e were weighed so that they were within the ranges of 0.25<a<0.4, 0.6<b<0.7, 0.6<c<0.7, and 0.3<d<0.4, respectively.

The weighed powders were wet ball milled using ethanol and zirconia beads to produce a raw material powder mixture. The resulting mixed powder was calcined at temperatures ranging from 600° C. to 1000° C. This calcined powder was wet mixed with predetermined amounts of MnCO₃ and SiO₂ powders, a binder such as polyvinyl butyral (PVB) resin, an organic solvent such as ethanol or toluene, and a plasticizer. SiO₂ was added as a sintering aid. The resulting slurry was used to coat a ceramic green sheet on a substrate and then dried. The substrate was, for example, a polyethylene terephthalate (PET) film.

An internal electrode pattern for the internal electrode layers was formed on the surface of the ceramic green sheet by screen printing or other methods using a metal conductive paste containing an organic binder. A silver-palladium alloy was used for the metal conductive paste.

Stack units were stacked so that the internal electrode layers and dielectric layers alternated, and so that the edges of the internal electrode layers were alternately exposed at both longitudinal end faces of the dielectric layers and alternately led to a pair of external electrodes with opposite polarity. Cover sheets were stacked on the top and bottom of the multilayer body consisting of stacked stack units and pressed and bonded. The ceramic material for the cover sheets was the same as that of the ceramic green sheets. The ceramic multilayer body obtained in this way was de-bindered in an N₂ atmosphere and then fired in air at temperatures ranging from 900° C. to 1150° C. The composition after firing was quantitatively evaluated by ICP atomic emission spectroscopy (ICP-AES).

(Examples 2-4) In Examples 2-4, the amount of MnCO₃ added as a sintering aid to the ceramic green sheets was changed from that of Example 1. All other conditions were the same as in Example 1.

(Comparative Example 1) In Comparative Example 1, neither MnCO₃ nor SiO₂ was added to the ceramic green sheets. All other conditions were the same as in Example 1.

(Comparative Example 2) In Comparative Example 2, MnCO₃ was not added to the ceramic green sheets. All other conditions were the same as in Example 1.

In the sintered dielectric layer, the silicon concentration present in the segregation portion on the grain boundary of the dielectric grains was obtained by silicon element mapping using a transmission electron microscope (TEM) equipped with an Energy Dispersive X-ray Spectroscopy (EDS) detector. With this structure, a clear contrast is obtained between the crystal grains, where silicon is barely detectable, and the segregation portion, where silicon is abundant. The silicon concentration in each region was measured by quantitatively analyzing the centers of the regions within the crystal grains and the segregation portions using EDX. This was performed on 10 dielectric grains, and the average silicon concentration in each region within the crystal grains and the segregation portions was calculated. The ratio of the average silicon concentration in the segregation portions to the average silicon concentration within the crystal grains (Si segregation portion/Si grain interior) was also calculated.

The manganese concentration present within the grain and the segregation portion of the dielectric grains was also measured using the same method as for silicon. The ratio of the average manganese concentration in the segregation portion to the average manganese concentration within the grain (Mn segregation portion/Mn grain interior) was also calculated.

The bismuth concentration present in the segregation portion at the grain boundary of the dielectric grain was also measured using the same method as for silicon.

These measurement results are shown in Table 1. As illustrated in Table 1, the (Si segregation portion/Si grain interior) ratio was 3.0 for Examples 1 to 3, 3.1 for Example 4, 0.0 for Comparative Example 1, and 3.1 for Comparative Example 2. The (Mn segregation portion/Mn grain interior) ratio was 9.3 for Example 1, 8.7 for Example 2, 4.0 for Example 3, 2.0 for Example 4, and 0.0 for Comparative Examples 1 and 2. These results indicate that the segregation portion containing manganese and silicon formed at the grain boundary of the dielectric grain in Examples 1 to 4. The bismuth concentration in the segregation portion was 10.9 at % for Example 1, 6.6 at % for Example 2, 2.0 at % for Example 3, and 2.1 at % for Example 4, and were 0.0 at % for Comparative Example 1 and 2.1 at % for Comparative Example 2. These results demonstrate that bismuth was present in the segregation portion in Examples 1 to 4.

TABLE 1

| | | | Bi | | | | | | |
|---|---|---|---|---|---|---|---|---|---|
| | | | CONCEN- | | | | | | |
| | | | TRATION | Bi | | | | | |
| | | | OF | VOL- | | | | | |
| | | | SEGRE- | ATIL- | AVER- | | | FRAC- | |
| | | | GATION | IZATION | AGE | VICKERS | | TURE | FRAC- |
| | Si_{SEGREGATION}/ | Mn_{SEGREGATION}/ | PORTION | RATE | GRAIN | HARD- | | TOUGH- | TURE |
| | Si_{GRAININTERIOR} | Mn_{GRAININTERIOR} | (at %) | (%) | SIZE | NESS | PORPSITY | NESS | STRENGTH |
| EXAMPLE 1 | 3.0 | 9.3 | 10.9 | 1.9 | ⊚ | ⊚ | ⊚ | ⊚ | ⊚ |
| EXAMPLE 2 | 3.0 | 8.7 | 6.6 | 2.3 | ⊚ | ⊚ | ⊚ | ◯ | ◯ |
| EXAMPLE 3 | 3.0 | 4.0 | 2.0 | 2.1 | ◯ | ⊚ | ◯ | ◯ | ◯ |
| EXAMPLE 4 | 3.1 | 2.0 | 2.1 | 2.4 | ◯ | ◯ | X | X | X |
| COMPAR- | 0.0 | 0.0 | 0.0 | 14 | X | ⊚ | X | X | X |
| ATIVE | | | | | | | | | |
| EXAMPLE 1 | | | | | | | | | |
| COMPAR- | 3.1 | 0.0 | 2.1 | 1.9 | X | X | X | X | X |
| ATIVE | | | | | | | | | |
| EXAMPLE 2 | | | | | | | | | |

The bismuth volatilization rate, which indicates the degree of bismuth volatilization, is expressed as a percentage of the bismuth concentration within the sintered crystal grains relative to the bismuth loading (concentration). The results are shown in Table 1. As shown in Table 1, the bismuth volatilization rate was low, at approximately 2%, in Examples 1 to 4. This is believed to be due to the suppression of bismuth volatilization caused by the formation of segregation portion containing manganese and silicon at the grain boundary of the dielectric grain. In contrast, the bismuth volatilization rate was high in Comparative Example 1. This is thought to be because the lack of segregation portion containing manganese and silicon prevented bismuth volatilization from being sufficiently suppressed.

The average grain size of the dielectric grains in the dielectric layer was measured by image analysis of SEM images taken at 2000× magnification using a scanning electron microscope (SEM). Each SEM image contained 300 or more crystal grains, and the average grain size obtained by image analysis of five SEM images was used to determine the average grain size. The average grain size of 3.0 μm or greater was judged as bad “x,” the average grain size of less than 3.0 μm and 2.0 μm or greater was judged as good “o”, and the average grain size of less than 2.0 μm was judged as very good “double circle.” The results are shown in Table 1. As shown in Table 1, Examples 1 to 4 were judged as very good “double circle” or good “o”. This is thought to be because bismuth volatilization was suppressed in Examples 1 to 4.

The strength of the dielectric layer was measured using a Vickers hardness tester under conditions of a load of 0.1 kgf and a holding time of 10 seconds, and was performed on the polished surface of the sample. The Vickers hardness of the sintered body was determined as the average value of 20 measurements. The Vickers hardness of less than 550 HV was judged as bad “x”, the Vickers hardness of less than 600 HV was judged as good “○”, and the Vickers hardness of 600 HV or greater was judged as very good “double circle”. The results are shown in Table 1. As shown in Table 1, Examples 1 to 4 were judged as very good “double circle” or good “○”. This is thought to be because the formation of segregation portion containing manganese and silicon increased the bonding strength between the dielectric grains. Comparative Example 2 was judged as bad “x”. This is thought to be because the formation of segregation portion containing both manganese and silicon did not result in a sufficient increase in the bonding strength between the dielectric grains.

These results demonstrate that Examples 1 to 4 were able to suppress bismuth volatilization while achieving high strength.

Below, experiments were conducted to examine additional effects.

Fracture toughness values were measured using a method conforming to the IF method specified in JIS R 1607. The average value of 20 measurements using the IF method was used to represent the fracture toughness value of the sintered compact. The fracture toughness value of less than 5.5 MPa·m^{0.5} was judged as bad “x,” the fracture toughness value of less than 6 MPa·m^{0.5} was judged as good “∘,” and the fracture toughness value of 6 MPa·m^{0.5} or greater was judged as very good “double circle.”

Fracture strength is the three-point bending strength value determined by a three-point bending test. Bending strength measurements were performed using sintered body samples with a support distance of 2.0 mm, a width of 1.6 mm, and a thickness of 0.4 mm. The fracture strength of the sintered body of this embodiment was determined by the average value of 10 measurements in a three-point bending test. The fracture strength of less than 150 MPa·m^{0.5} was judged as bad “x”, the fracture strength of less than 200 MPa·m^{0.5} was judged as good “o”, and the fracture strength of 200 MPa m^{0.5} or greater was judged as very good “double circle”.

Porosity was determined by observing the mirror-polished surface of the sintered body with a scanning electron microscope, measuring the pore area for each of five SEM images taken at a magnification of 2000×, and averaging the pore area relative to the observed area to determine the porosity. If the sintered body is overly or insufficiently dense or is too densified, the number of pores in the structure increases. The low porosity is expected to improve fracture strength and toughness. The porosity of 2.0% or greater was judged as bad “x”, the porosity of less than 2.0% and 1.0% or greater was judged as good “o”, and the porosity of less than 1.0% was judged as very good “double circle”.

In Examples 1 to 4, the higher the ratio (Mn segregation portion/Mn grain interior), the higher the fracture toughness and fracture strength. The reason for the improved fracture toughness is thought to be that the formation of segregation portion containing manganese and silicon acts as a diffusion barrier for other elemental species, suppressing grain growth. This, in turn, increases the grain boundary volume in the crystalline structure, further strengthening the crack propagation suppression effect of the segregation portion. The reason for the improved fracture strength is thought to be that the formation of segregation portion suppresses grain growth while increasing density, thereby suppressing the formation of pores that serve as fracture initiation points.

Although the embodiments of the present invention have been described in detail, it is to be understood that the various changes, substitutions, and alterations could be made hereto without departing from the spirit and scope of the invention.

1. A multilayer ceramic electronic device comprising:
at least two internal electrode layers facing each other;
a dielectric layer that is sandwiched by the two internal electrode layers, has a plurality of dielectric grains including bismuth, sodium, niobium, titanium, silicon, and manganese, and has a segregation portion that is arranged on a grain boundary of the plurality of dielectric grains and includes bismuth, silicon, and manganese; and
external electrodes respectively electrically connected to the two internal electrode layers.

2. The multilayer ceramic electronic device as claimed in claim 1,
wherein a main phase of the dielectric layer is (BiₐNa_{b})(Ti_{c}Nb_{d})O₃ composited with silicon and manganese, and
wherein 0.1<a<0.5, 0.4<b<0.8, 0.4<c<0.8, and 0.2<d<0.5 are satisfied.

3. The multilayer ceramic electronic device as claimed in claim 1,
wherein a silicon concentration of the segregation portion is at least three times a silicon concentration of the plurality of dielectric grains.

4. The multilayer ceramic electronic device as claimed in claim 1,
wherein a bismuth concentration of the segregation portion is 2.0 at % or more.

5. The multilayer ceramic electronic device as claimed in claim 1,
wherein a manganese concentration of the segregation portion is twice or more as a manganese concentration of the plurality of dielectric grains.

6. The multilayer ceramic electronic device as claimed in claim 1,
wherein an average grain size of the plurality of dielectric grains is less than 3.0 μm.

7. A dielectric ceramic composition comprising:
a plurality of dielectric grains including bismuth, sodium, niobium, titanium, silicon, and manganese; and
a segregation portion that is arranged on a grain boundary of the plurality of dielectric grains and includes bismuth, silicon, and manganese.
